(19) United States
(12) Patent Application Publication
(10) Pub. No.: US 2007/0175354 A1
(43) Pub. Date: Aug. 2, 2007

(54) Rail assembly, rail bodies and associated production method

(76) Inventor: Jurg Jakob, Ittigen (CH)

Correspondence Address: GREER, BURNS & CRAIN, 300 S WACKER DR, 25TH FLOOR, CHICAGO, IL, 60606, US

(21) Appl. No.: 10/557,763

(22) PCT Filed: May 19, 2004
(86) PCT No.: PCT/CH04/00305

§ 371 Date: Nov. 22, 2006

(30) Foreign Application Priority Data
May 21, 2003 (DE) 907/03

(51) Int. Cl. B60L 13/00

(52) U.S. Cl. 104/294

(57) ABSTRACT

The inventive rail bodies of the rail assembly consist of a base and cover plate which form a running surface of said rail assembly. The corners of the rail bodies are provided with recesses in which fixing elements whose upper face flashes with the running surface are arranged. The traversal edges of the recesses from a diagonal with respect to a longitudinal direction of the rail body in such a way that a wheel is not exposed to slack impacts when passing between the running surface and the rail assembly. Said simple design makes it possible to attain an impact-free wheel running.

### ACKNOWLEDGMENT OF RELATED APPLICATIONS

The present application claims the priority of Swiss patent application 907/03, which was filed on 21 May 2003, and whose disclosure is hereby incorporated in its entirety into the present application by reference.

The present application relates to a rail system, a rail body, and a method for their manufacture according to the preamble of claim 1.

A rail system of this type is known from WO 01/38124. It is made up of a plurality of rail elements situated one after the other. Each rail element contains the coils of a linear drive mechanism for the vehicles, and forms running surfaces for the wheels of the vehicle. Rail elements situated one after the other are connected via rectangular fastening plates that are placed in rectangular recesses in the running surfaces.

In order for a thermal expansion of the rail elements to remain possible, a gap must be provided between the rail elements; however, when traveled over this results in undesirable shocks and signs of wear. The solution of this problem is the object of the present invention.

This object is achieved by the subject matter of the independent claims. This is achieved in that the transverse edges of the recesses for the fastening elements run obliquely, i.e., not at right angles or parallel, to the longitudinal direction of the rails. The corresponding terminating edges of the fastening elements run essentially parallel to these transverse edges. Moreover, the upper sides of the fastening elements are situated essentially flush to the running surface, and are positioned in such a way that they temporarily receive the pressure force of the wheels between the rail elements.

This design has the result that the pressure force of the wheels in the area of the transverse edges moves gradually from the running surface of the rail element to the fastening elements, or vice versa, so that an undesirable shock is at least partly avoided. In the area between the rail elements, the pressure force is received by the fastening elements, so that a gap between the rail elements also no longer causes impacts.

In the present specification, the terms “upper” and “lower” are to be understood such that the running surface or running surfaces of the rail elements define the “upper side” even if it/they are directed towards the floor of a space. “Front” and “rear” designate the orientations in the direction of travel of the vehicles.

Preferably, each fastening element has a fastening plate that is situated in the recess and that forms the upper side of the fastening element. Via a traction mechanism, the plate is supported against the lower side, situated opposite the upper side, of the rail elements. This enables a simple and stable connection.

The recesses are preferably formed by areas of a cover plate that are left open (i.e., omitted).

In addition, the present invention relates to a corresponding rail element, and to a manufacturing method for it.

Additional preferred embodiments, as well as applications, of the present invention result from the dependent claims, as well as from the following description, which is based on the Figures.

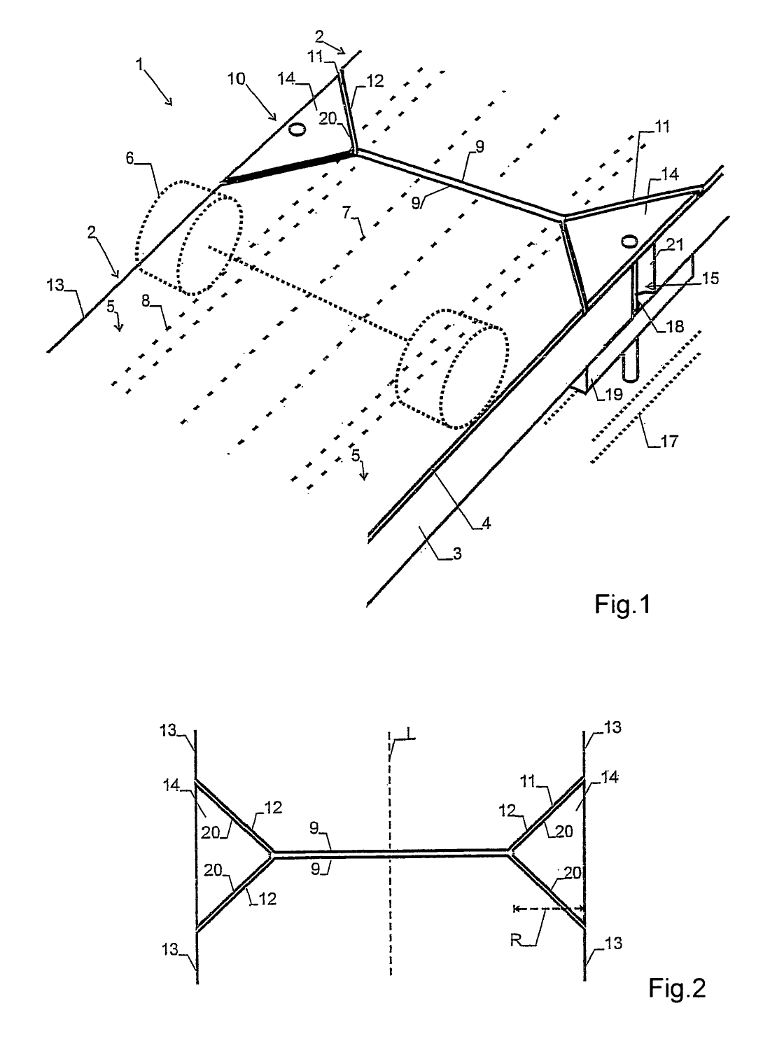

FIG. 1 shows a view of two adjacent rail elements of a preferred embodiment of the present invention,

FIG. 2 shows a top view of the embodiment in FIG. 1,

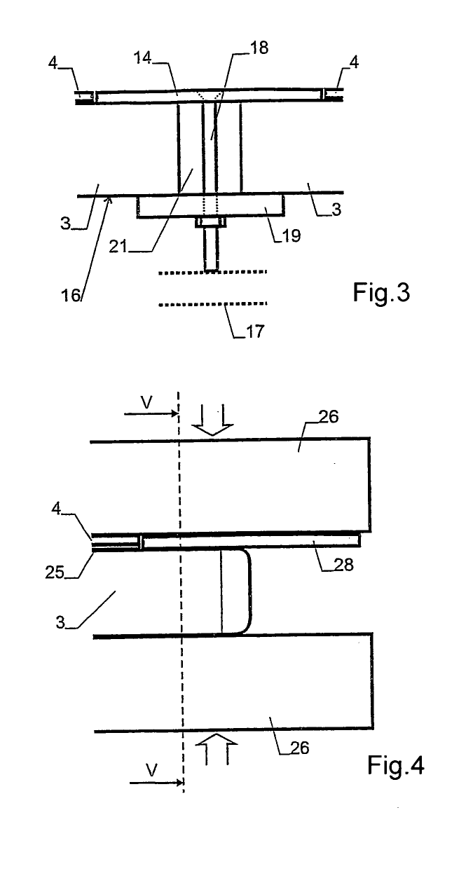

FIG. 3 shows a side view of the embodiment in FIG. 1,

FIG. 4 shows a side view of a rail element during manufacture,

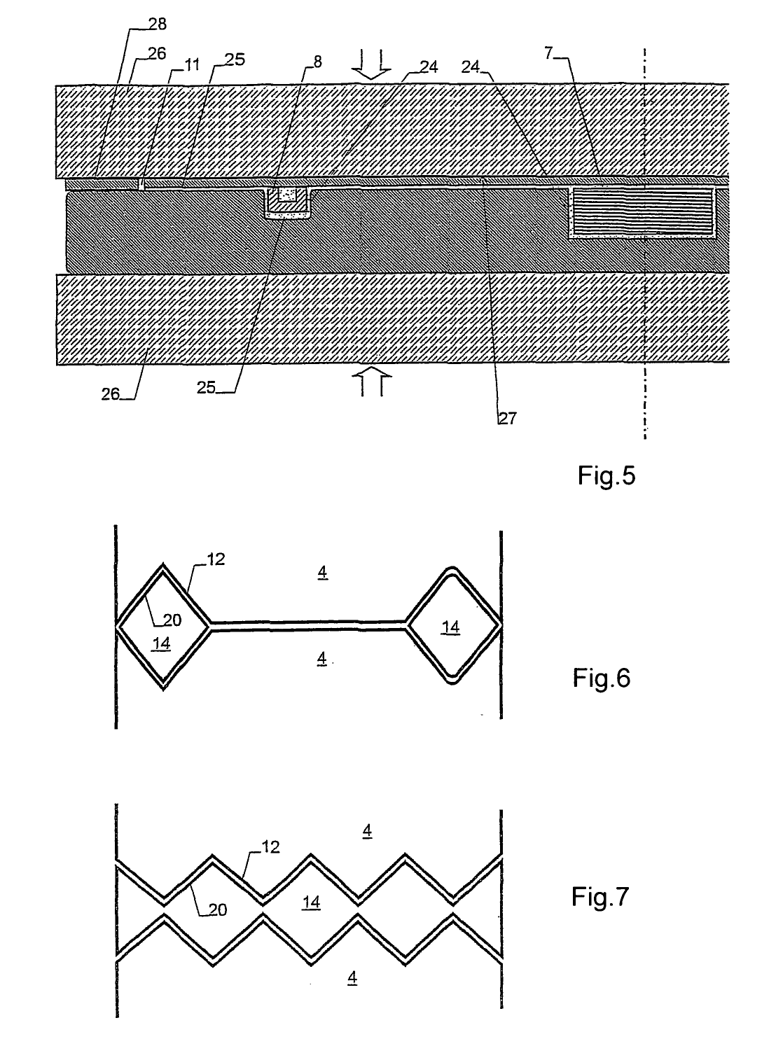

FIG. 5 shows a section along line V-V of FIG. 4,

FIG. 6 shows a top view of a second or third variant embodiment, and

FIG. 7 shows a top view of a fourth variant embodiment.

In FIGS. 1-3, a rail system 1 is shown that is made up of a plurality of rail elements 2 situated one after the other. Each rail element 2 is made of a base part 3 and a cover plate 4. The cover plate 4 is preferably made of metal, and forms two running surfaces 5 that run parallel to the longitudinal direction L of the rail system, and on which the wheels 6 of a vehicle (shown only schematically) run. It has cross-sectional thicknesses that preferably vary from location to location, and/or can be formed from one or more formed parts having a more complex shape, as long as it forms running surfaces 5.

The coils of a linear drive mechanism 7 and iron profiles 8 for a magnetic guide system, as is described for example in WO 01/38124, are integrated into rail element 2 (shown in broken lines in FIG. 1). However, other kinds of drive mechanisms and guide systems can be used.

Seen from the running surfaces, rail elements 2 are preferably essentially rectangular, having two longitudinal sides 13 that run parallel to the longitudinal direction L of the rails, and having two transverse sides 9 that run perpendicular thereto. Transverse sides 9 abut the respectively closest rail element 2, a gap being formed between the transverse sides 9 of adjacent rail elements 2 that is able to accept thermal dilatations of rail elements 2.

In corner points 10 between longitudinal sides 13 and transverse sides 9, recesses 11 are situated in running surfaces 5 that, in a preferred embodiment, each have the shape of a triangle, as is shown in FIG. 2 in a top view. Recesses 11 extend from the respective longitudinal side 13 and transverse side 9 up to a transverse edge 12, which in the present example stands at an angle of approximately 45° to the longitudinal direction L of the rails. The width of recesses 11 corresponds approximately to the width of running surfaces 5, i.e., approximately the width of a wheel. The floor of each recess 11 is formed by base part 3, and transverse edge 12 is formed by cover plate 4, which is left open in the area of recesses 11.

In recesses 11 there are situated fastening elements 14, each consisting of a triangular fastening plate. The upper side of each fastening element is essentially flush with the respective running surface 5. Each fastening element 14 is seated in the opposed recesses 11 of two adjacent rail elements 2, and orients these elements in relation to one another.

Via traction mechanisms 15, fastening elements 14 are clamped against lower side 16, situated opposite running side 5, of the rail elements, and are connected to an assembly device 17 (shown only in broken lines). The traction mechanisms include for example a traction rod 18 that is anchored in the respective fastening element 14 and that is supported on the rear side 16 of base part 3 via a support plate 19.

The corners of rail elements 2 are fashioned in such a way that two successive rail elements together form a recess 21 on the side of the rail system, which recess accepts traction rod 18.

As already mentioned, fastening elements 14 are used to fasten rail elements 2, as well as for the relative orientation of adjacent rail elements in the horizontal and vertical direction. At the same time, they enable a practically shock-free running of wheels 6 in the transition between rail elements.

The latter can be seen in particular in FIG. 2. Here, a line R is shown that runs perpendicular to the longitudinal direction of the rails and that has the width of a wheel. This straight line corresponds to the line of contact of the wheel. As can be seen, transverse edges 11, and the corresponding terminating edges 20, running parallel to these transverse edges, of fastening elements 14 run so obliquely (e.g., at approximately 45°) to longitudinal direction L that at all times the line R runs at least partly through running surface 5 or through fastening elements 14, so that the wheel is continuously in contact with one of these parts, thus avoiding shocks. In addition, the transition between the parts does not take place with a sudden shock, but rather continuously, which reduces vibrations and shocks in the case of slight differences in height that may occur.

A spacing can be provided between transverse edges 11 and the corresponding terminating edges 20, which compensates thermal dilatations of rail elements 2 without resulting in uneven running of wheels 6.

In addition, the upper side of fastening elements 14 is preferably slightly convexly curved, e.g. by approximately 100 μm, which reduces the impacts on the wheel in the case of height differences that may be present between running surface 5 and fastening element 14.

The manufacture of the rail elements is illustrated in the following on the basis of FIGS. 4 and 5.

In a first step, base part 3 and cover plate 4 are manufactured. Base part 3 is preferably made of a formed element made of glass fiber-reinforced plastic. In the upper side of the formed element, recesses 24 are provided in order to accept the coils of linear drive mechanism 7 and iron profiles 8, as well as additional elements that may be integrated.

A hardening intermediate layer 25 is then applied on the surface of the base part, except for the area having recesses 11. Components 7 and 8 are placed onto this intermediate layer with cover plate 4. Reference objects 28 having the thickness of fastening elements 14 are situated in the area of the recesses. The packet manufactured in this way is clamped between support elements 26; at least the support element at the side of cover plate 4 forms a flat support surface 27 in the area of running surfaces 5 and forms fastening elements 14. With support elements 26, base part 3 is now pressed against cover plate 4 and the reference objects, and cover plate 4 and the reference objects are pressed against support surface 27. In this position, intermediate layer 25 is at least partly hardened. This procedure ensures that the distance between the floor of recess 11 and running surface 5 corresponds to the thickness of reference object 28 or of fastening elements 14. This is advantageous because it allows relatively large manufacturing tolerances for base part 3. It is presumed that the thickness of cover plate 4 is at most as large as the thickness of fastening elements 14 or of reference objects 28. If intermediate layer 25 is not arbitrarily thin in the area of running surfaces 5, the thickness of cover plate 4 must be correspondingly smaller than that of fastening elements 14 or of reference objects 28.

After the hardening of intermediate layer 25, support elements 26 and the reference objects can be removed, and the rail element is essentially finished.

The exemplary embodiment depicted up to this point is only one of many variants of the present invention.

Instead of the traction mechanism 15 shown in the Figures for fastening elements 14, other devices can for example be used that allow fastening elements 14 to be supported on lower side 16 or in base part 3, and that ensure that despite manufacturing tolerances the base part the floor surfaces of recesses 11 adjacent base part 3 are at the same height. For example, traction plates can also be provided that extend downward from the outer edges of fastening elements 14 and that are connected to an arm that can be pivoted towards lower side 16, and that has a suitable detent mechanism. Springs can be provided between the arm and the base parts 3 in order to compensate manufacturing tolerances. It is also possible to provide special parts on base part 3, such as for example a fastening projection, that work together with traction mechanism 15.

The shape of recesses 11 and of fastening elements 14 can vary, as long as transverse edge 12 and the corresponding terminating edges 20 run for the most part obliquely and not at a right angle to longitudinal direction L of the rails, so that shocks to the wheels are avoided. FIGS. 6 and 7 show two possible specific embodiments that meet these conditions; in the specific embodiment according to FIG. 7, only a single fastening element is provided.

While preferred embodiments of the present invention are described in the present application, it is to be emphasized that the present invention is not limited to these, and can also be realized in other ways within the scope of the following claims.

1. Rail system comprising,
a plurality of rail elements situated one after the other, each rail element having
at least one running surface, extending in the longitudinal direction of the rails, in the area of the wheels of a vehicle that is to be accepted,
at least parts of a linear drive mechanism and of a guide system for the vehicle, and
two transverse sides that run transverse to the longitudinal direction of the rails and that each abut the transverse sides of adjacent rail elements,
at least one recess being provided in the running surface, starting from each transverse side, and fastening elements for the rail elements being situated in the recesses, wherein
a transverse edge that terminates the recesses in the longitudinal direction of the rails runs obliquely and not at a right angle to the longitudinal direction of the rails,
each fastening element has front and rear terminating edges that run essentially parallel to the transverse edges, and
the fastening elements are situated with an upper side essentially flush with the running surface and are fashioned for the temporary reception of the pressure force of the wheels between the rail elements.

2. Rail system according to claim 1, wherein the transverse edge of each recess is situated at a distance from the closest terminating edge of the fastening element, the transverse edge and the terminating edge running such that each straight line running perpendicular to the longitudinal direction of the rails in the plane of the running surface runs at least partly through the running surface of the element, or at least partly through the fastening element, in such a way that a wheel to be accepted is continuously in contact either with the running surface of the rail element and/or with the fastening element.

3. Rail system according to claim 1, wherein the rail elements have longitudinal sides that run in the longitudinal direction of the rails, and that one of the recesses is situated in each corner point between a longitudinal side and a transverse side.

4. Rail system according to claim 3, wherein the recess extends from the longitudinal side and the transverse side to the transverse edge, and that the fastening elements extend from the longitudinal sides towards the transverse edges.

5. Rail system according to claim 1, wherein each fastening element has a fastening plate that is situated in the recess and that forms the upper side of the fastening element, and that the fastening plate is supported, via a traction mechanism, against a side of the rail elements situated opposite the upper side.

6. Rail system according to claim 5, wherein each pair of mutually abutting rail elements forms, in the area of the corners, lateral recesses through which the traction mechanism extends.

7. Rail system according to claim 1, wherein the running surface is formed by at least one cover plate of the rail element, the cover plate being left open in the area of the recesses, the cover plate being situated on a base part of the rail element, and the base part forming the floor of the recesses.

8. Rail system according to claim 5, wherein the cover plate and an intermediate layer situated between the cover plate and the base part together have essentially the same thickness as the fastening plate.

9. Rail system according to claim 1, wherein the fastening elements are convexly curved on an upper side.

10. Rail system according to claim 1, wherein the fastening elements are anchored in an area of the rail element situated opposite the running surfaces.

11. Rail system according to claim 1, wherein the fastening elements are essentially triangular in shape.

12. Rail element for a rail system according to claim 1, having at least one running surface that extends in the longitudinal direction of the rails in the area of the wheels of a vehicle that is to be accepted, having at least parts of a linear drive mechanism for the vehicle, and having two transverse sides that run transverse to the longitudinal direction of the rails, each of these transverse sides being provided so as to abut the transverse sides of adjacent rail elements, at least one recess for accepting a fastening element being situated in the running surface beginning from each transverse side, wherein a transverse edge that terminates the recesses in the longitudinal direction of the rails runs obliquely and not at a right angle to the longitudinal direction of the rails.

13. Method for manufacturing rail elements according to claim 1, comprising the following steps:
manufacturing a base part that forms a floor surface of the recesses, and manufacturing a cover plate that forms the at least one running surface,
situating a hardening intermediate layer between the base part and the cover plate,
situating reference objects, having the thickness of the corresponding fastening elements, in the recesses,
pressing the base part against the cover plate and the reference objects, and pressing of the cover plate and of the reference objects against a support surfaces, so that the reference objects define the distance of the base part from the support surface, and
at least partial hardening of the intermediate layer.

14. Rail system according to claim 4, wherein each pair of mutually abutting rail elements forms, in the area of the corners, lateral recesses through which the traction mechanism extends.

15. Rail system according to claim 6, wherein the cover plate and an intermediate layer situated between the cover plate and the base part together have essentially the same thickness as the fastening plate.

16. Rail system according to claim 7, wherein the cover plate and an intermediate layer situated between the cover plate and the base part together have essentially the same thickness as the fastening plate.
